(19) United States
(12) Patent Application Publication
(10) Pub. No.: US 2014/0010051 A1
(43) Pub. Date: Jan. 9, 2014

(54) METHOD AND APPARATUS FOR TRANSMITTING SOUND WAVES IN WATER

(71) Applicant: Electronics and Telecommunications Research Institute, Daejeon (KR)

(72) Inventors: Sung Eun KIM, Daejeon (KR); Jung Hwan HWANG, Daejeon (KR); Tae Wook KANG, Daejeon (KR); Sung Weon KANG, Daejeon (KR); Sung Won SOHN, Daejeon (KR); Kyung Hwan PARK, Daejeon (KR)

(21) Appl. No.: 13/935,408

(22) Filed: Jul. 3, 2013

(30) Foreign Application Priority Data
Jul. 5, 2012 (KR) 10-2012-0073140

(51) Int. Cl. G10K 11/18

(52) U.S. Cl. CPC G10K 11/18
USPC 367/131

(57) ABSTRACT

Provided are a method and apparatus for transmitting sound waves in water. The method for transmitting sound waves in water includes generating a sound wave signal, and transmitting the sound wave signal in water, generating a compensation signal for preventing distortion due to water vibration in an audible frequency band, and simultaneously transmitting the compensation signal and the sound wave signal in water. Accordingly, an apparatus for receiving sound signals is not required, and direct contact between a human body and an apparatus for transmitting sound signals is not required, thereby improving convenience of use. In addition, even when a human body is constantly moving, a superior contact condition may be provided, and therefore sound waves may be more effectively transmitted to a user.

### CLAIM FOR PRIORITY

This application claims priority to Korean Patent Application No. 10-2012-0073140 filed on Jul. 5, 2012 in the Korean Intellectual Property Office (KIPO), the entire contents of which are hereby incorporated by reference.

### BACKGROUND

1. Technical Field

Example embodiments of the present invention relate in general to sound wave transmission technology, and more specifically, to a method and apparatus for transmitting sound waves to a human body in water.

2. Related Art

Human communication refers to technology in which a cable of a typical electronic product which is used to transmit signals is eliminated based on a principle in which a human body can be electrified, and signals are transmitted through changes in electrical energy using the human body instead of cables.

Meanwhile, human body sound transmission technology refers to technology for transmitting sound signals using a human body as a transmission medium. In human body sound transmission technology, sound signals are generated in such a manner that sound signals modulated into high-frequency band signals and high-frequency signals for demodulating sound signals are applied to a human body, and frequencies of the applied two kinds of signals are mixed by a non-linear action of the human body, compensating for interference between signals, while the two kinds of signals are transmitted through the human body.

In an existing sound signal transmission apparatus for transmitting sound signals using a human body as a transmission medium, one or two sound transmission units provided in the sound signal transmission apparatus transmits signals while securely in contact with a human body.

When the sound transmission unit is not in contact with the human body, large loss in transmission of sound signals may occur due to an impedance difference. The signals transmitted from the sound transmission unit may be transmitted through the human body in contact with the sound transmission unit, and users may hear sound through their auditory organs.

However, as described above, in the conventional human body sound transmission technology, the sound signal transmission apparatus must be in contact with the human body, which may cause discomfort in use due to limitations of activities of the human body.

In addition, when the human body is moving, a contact condition between the sound signal transmission apparatus and the human body becomes worse, and therefore transmission of sound signals may be incomplete.

### SUMMARY

Accordingly, example embodiments of the present invention are provided to substantially obviate one or more problems due to limitations and disadvantages of the related art.

Example embodiments of the present invention provide a method for transmitting sound waves in water, which may transmit sound waves to a human body in water, even without contacting the human body.

Example embodiments of the present invention also provide an apparatus for transmitting sound waves in water, which may transmit sound waves to a human body in water even without contacting the human body.

In some example embodiments, a method for transmitting sound waves in water includes: generating a sound wave signal; and transmitting the sound wave signal in water.

Here, the method may further include: generating a compensation signal for preventing distortion due to water vibration in an audible frequency band; and simultaneously transmitting the compensation signal and the sound wave signal in water.

In other example embodiments, a method for transmitting sound waves in water includes: generating a first ultrasonic signal and a second ultrasonic signal; and transmitting each of the first ultrasonic signal and the second ultrasonic signal in water, wherein the first ultrasonic signal and the second ultrasonic signal are transmitted so as to cross each other in a specific location in water.

Here, the generating of the first ultrasonic signal and the second ultrasonic signal may include receiving a sound wave signal, and generating the first ultrasonic signal and the second ultrasonic signal using the sound wave signal.

In addition, the generating of the first ultrasonic signal and the second ultrasonic signal using the sound wave signal may include performing pre-distortion for compensating for distortion that occurs when the first ultrasonic signal and the second ultrasonic signal are restored to the sound wave signal.

In addition, the performing of the pre-distortion may divide the first ultrasonic signal and the second ultrasonic signal by the square of frequency of the sound wave.

In still other example embodiments, an apparatus for transmitting sound waves in water includes: a sound wave generating unit that generates an ultrasonic signal by modulating a provided sound wave signal; a pre-processing unit that performs pre-distortion on the ultrasonic signal; and a transmission unit that transmits, in water, the ultrasonic signal on which the pre-distortion has been performed.

Here, the pre-processing unit may divide the ultrasonic signal by the square of frequency of the sound wave signal so as to compensate for distortion occurring when the ultrasonic signal is restored to the sound wave signal.

### BRIEF DESCRIPTION OF DRAWINGS

The above and other features and advantages of the present invention will become more apparent by describing in detail example embodiments of the present invention with reference to the accompanying drawings, in which:

FIG. 1 is a conceptual diagram showing a method for transmitting sound waves in water according to an embodiment of the present invention;

FIG. 2 is a diagram showing an acoustic impedance for each medium;

FIG. 3 is a flowchart showing a method for transmitting sound waves in water according to an embodiment of the present invention;

FIG. 4 is a block diagram showing a configuration of an apparatus for transmitting sound waves according to an embodiment of the present invention;

FIG. 5 is a conceptual diagram showing a method for transmitting sound waves in water according to another embodiment of the present invention;

FIG. 6 is a flowchart showing a method for transmitting sound waves in water according to another embodiment of the present invention; and

FIG. 7 is a block diagram showing a configuration of an apparatus for transmitting sound waves according to another embodiment of the present invention.

### DESCRIPTION OF EXAMPLE EMBODIMENTS

Example embodiments of the present invention are disclosed herein. However, specific structural and functional details disclosed herein are merely representative, for the purpose of describing example embodiments of the present invention. The present invention may be embodied in many alternate forms and should not be construed as limited to the example embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

With reference to the appended drawings, exemplary embodiments of the present invention will be described in detail below. Elements that appear in more than one figure or are mentioned in more than one place in the detailed description are denoted by the same reference numerals throughout the application and are only described in detail once.

In a method for transmitting sound waves in water according to an embodiment of the present invention, sound waves may be transmitted through water using an apparatus for transmitting sound waves in water according to an embodiment of the present invention and the transmitted sound waves may be transmitted to a human body.

Since water and the human body have similar acoustic impedances, the sound wave signal transmitted in water may be transmitted to a human body to stimulate an auditory organ of the human body so that a user may detect sound.

Alternatively, in the present invention, ultrasonic signals may be transmitted in water to generate sound waves only in a specific area based on non-linear characteristics of water, and the sound waves may be transmitted to a human body using water as a transmission medium, so that a user may detect sound.

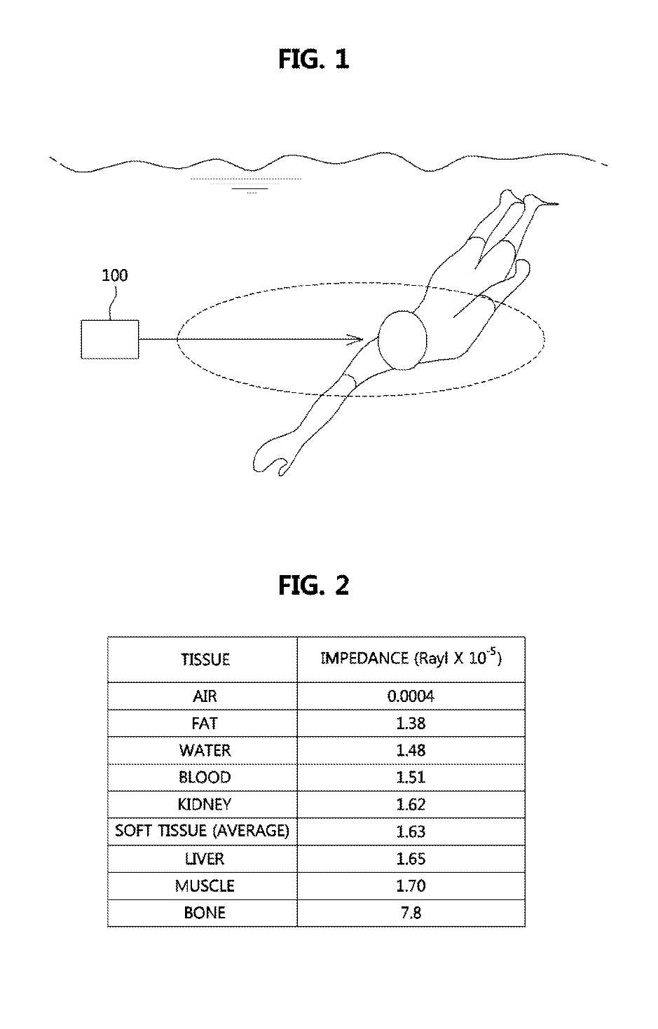

FIG. 1 is a conceptual diagram showing a method for transmitting sound waves in water according to an embodiment of the present invention, FIG. 2 is a diagram showing an acoustic impedance for each medium.

Referring to FIGS. 1 and 2, in the method for transmitting sound waves in water according to an embodiment of the present invention, sound wave signals may be transmitted in water using an apparatus 100 for transmitting sound waves, so that a human body may detect the transmitted sound wave signals.

Since the human body basically has similar impedance to water, most sound wave signals transmitted in water may be transmitted to the human body, and the transmitted sound wave signals may stimulate an auditory organ of the human body so that a user may detect sound. The method for transmitting sound waves in water is different from an existing method for transmitting sound waves through air, and in the method for transmitting sound waves in water, users may detect vibration of sound waves through water.

In a general method for transmitting and receiving sound signals (or sound waves), when a user is in water, the user may wear a sound wave transmitter near his or her ears to hear sound waves output from the sound wave transmitter and then transmitted using air (for example, air between the sound wave transmitter and the eardrums) as a medium. However, in the general method, the user always has to wear the sound wave transmitter.

In the method for transmitting sound waves in water according to an embodiment of the present invention, in order to overcome the above disadvantage, when a user is in water, which has similar impedance to the human body, the apparatus 100 for transmitting sound waves or a transmission unit (see 130 of FIG. 4) of the apparatus 100 may be located in water to transmit sound waves in water, so that the sound waves may be transmitted to the user's body through water.

In addition, in the method for transmitting sound waves in water according to an embodiment of the present invention, in order to improve the clarity of the sound waves transmitted to the body of the user in water, distortion of a sound wave band due to water vibration in an audible frequency band may be determined in advance, compensation signals for compensating for the distortion may be transmitted together with the sound waves, and sound wave signals on which pre-processing for compensating for the distortion has been performed may be transmitted, so that a user may detect only the sound wave signals transmitted from the apparatus 100 without detecting the distortion of the sound waves due to the vibration of the water.

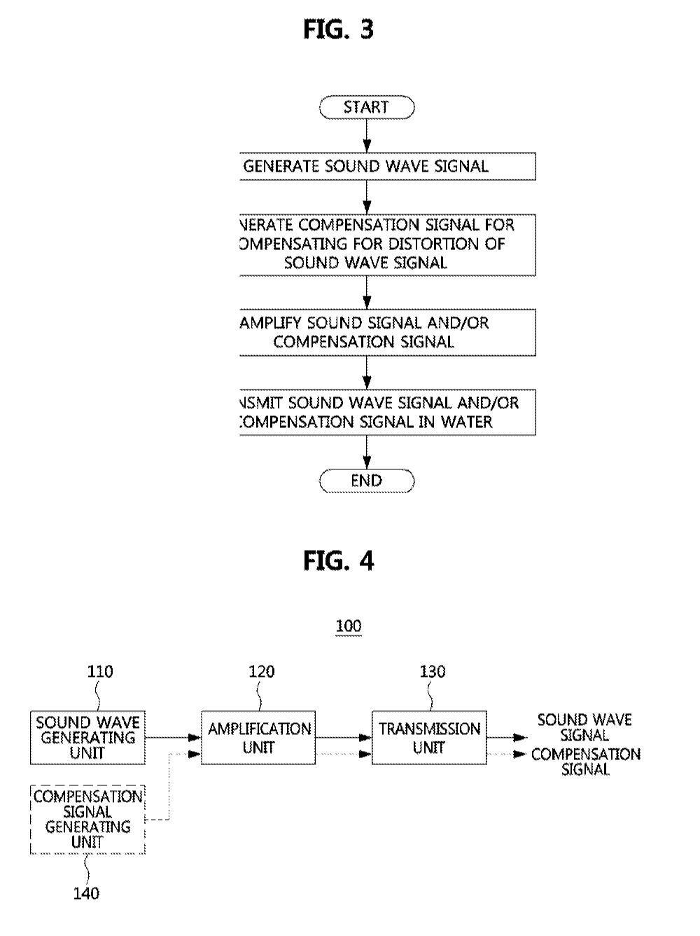

FIG. 3 is a flowchart showing a method for transmitting sound waves in water according to an embodiment of the present invention.

Referring to FIG. 3, in step S301, the apparatus for transmitting sound waves generates sound signals. Here, the apparatus for transmitting sound waves may use sound signals provided from a sound source as is, or may change the sound signals to have a specific format set in advance.

Next, in step S303, the apparatus generates compensation signals for compensating for distortion of the sound signals due to water vibration. Here, the apparatus may determine the water vibration in real-time to generate the compensation signals corresponding to the determined water vibration, or determine the water vibration in advance to generate the compensation signals using the water vibration determined in advance.

Next, in step S305, the apparatus amplifies the amplitude of the signals so that the sound signals and the compensation signals may be transmitted to a human body in water. Here, the apparatus may synthesize the sound signals and the compensation signals and then amplify the synthesized signals, or amplify the sound signals and the compensation signals separately.

In step S307, the apparatus transmits the amplified sound signals and compensation signals in water. Here, the amplified sound signals and compensation signals may be transmitted separately, or the synthesized signals of the sound signals and the compensation signals may be transmitted.

FIG. 4 is a block diagram showing a configuration of an apparatus for transmitting sound waves according to an embodiment of the present invention.

Referring to FIG. 4, the apparatus 100 for transmitting sound waves according to an embodiment of the present invention may include a sound wave generating unit 110, an amplification unit 120, and a transmission unit 130. In addition, the apparatus 100 may further include a compensation signal generating unit 140.

The sound wave generating unit 110 may receive sound wave signals (or sound data) of an audible frequency band provided from a sound source and transmit the received sound wave signals to the amplification unit 120, or convert the sound wave signals into a specific format and then provide the converted sound wave signals to the amplification unit 120. Here, the sound wave generating unit 110 may read sound data stored in the apparatus 100 and then perform digital-to-analog conversion on the read sound data to provide the sound data to the amplification unit 120, or provide sound wave signals provided from an external device to the amplification unit 120. In addition, the sound wave generating unit 110 may convert the sound wave signal into a specific format such as a pulse coded modulation (PCM) format.

The amplification unit 120 may amplify the sound wave signals to a predetermined level so that the provided sound wave signals may be transmitted to a user's body through water.

The transmission unit 130 may transmit, in water, ultrasonic signals amplified through direct contact with water.

In addition, the compensation signal generating unit 140 may generate compensation signals for compensating for distortion of the sound wave signals based on water vibration. Here, the compensation signals generated by the compensation signal generating unit 140 may be amplified to have the same amplitude as the sound wave signals through the amplification unit 120 to be transmitted in water through the transmission unit 130, and remove distortion of the sound wave signals due to water vibration in the audible frequency band.

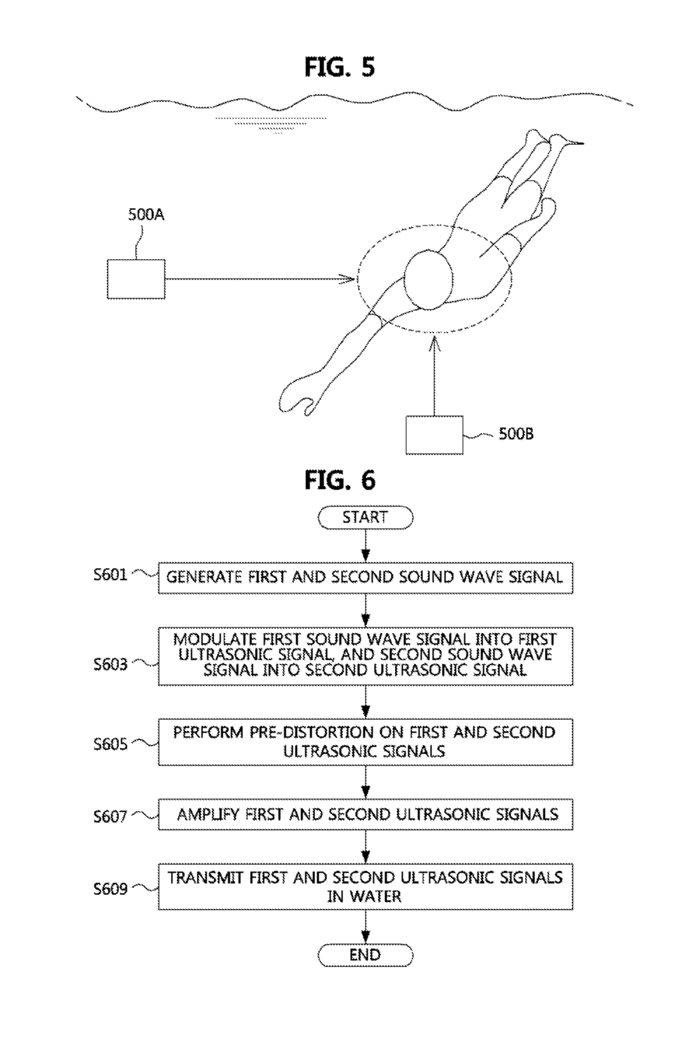

FIG. 5 is a conceptual diagram showing a method for transmitting sound waves in water according to another embodiment of the present invention.

Referring to FIG. 5, in the method for transmitting sound waves in water according to another embodiment of the present invention, sound waves may be transmitted only in a specific position of water where a user is located by utilizing ultrasonic waves.

That is, the method for transmitting sound waves in water according to another embodiment of the present invention may use non-linear characteristics of water, and generate sound waves signals based on the non-linear characteristics of water at a point where two kinds of ultrasonic signals transmitted from two apparatuses 500a and 500b for transmitting sound waves in water cross each other.

The sound wave signals generated at the point where the two kinds of ultrasonic signals cross each other as described above may be transmitted to a user's body as shown in FIG. 1, and this is significantly different from an existing method for transmitting sound waves through air.

Alternatively, the ultrasonic signals transmitted in water may be transmitted to a human body, which has similar impedance to water, and the ultrasonic signals transmitted to the human body may generate sound waves signals due to non-linear characteristics of the human body, so that the human body may detect the sound wave signals to receive sound waves.

Meanwhile, in another embodiment of the present invention, a single side band amplitude modulation (SSB AM) method may be utilized when modulating sound waves into ultrasonic waves and transmitting the modulated ultrasonic waves, and in this case, carrier signals may be simultaneously transmitted.

The ultrasonic signals transmitted as described may generate sound waves signals while passing through a non-linear medium such as water or a human body, and in this instance, distortion of the generated sound wave signals may occur due to characteristics of the non-linear medium.

In the method for transmitting sound waves in water according to another embodiment of the present invention, in order to minimize distortion of the sound wave signals transmitted to the human body through ultrasonic waves, pre-distortion for compensating for the distortion may be performed before transmitting the ultrasonic signals.

The pre-distortion may differ depending on a modulation method.

For example, when the ultrasonic signals are modulated through SSB AM, the generated sound wave signals may have characteristics in which the amplitude of restored sound waves increases in proportion to the square of frequency due to non-linear characteristics of water or the human body.

The following Equation 1 may represent sound wave signals restored from the ultrasonic waves.

$${p}_{s} = \frac{{βp}_{0}^{2} {a}^{2} m {ω}^{2}}{8 {ρ}_{0} {c}_{0}^{4} α r} sin ω t \qquad [ Equation 1 ]$$

In Equation 1, β denotes non-linear characteristics of a medium, p₀ denotes transmitted ultrasonic signals, pₛ denotes restored sound waves, and a denotes a radius of a cross-sectional area of transmission. In addition, m denotes a modulation index, ρ₀ denotes a density of a medium, c₀ denotes a transmission speed in the medium, a denotes an attenuation coefficient of ultrasonic signals in the medium, and r denotes a transmission distance of ultrasonic signals.

Meanwhile, in Equation 1, ω denotes a frequency component of restored sound waves, and may affect the amplitude of the restored signal. That is, the amplitude of the sound wave signals restored from the ultrasonic signals may increase in proportion to the square of ω. In order to minimize the distortion, as shown in the following Equation 2, Equation 1 is divided by ω² in advance.

$${p}_{s} = \frac{{βp}_{0}^{2} {a}^{2} m }{8 {ρ}_{0} {c}_{0}^{4} α r} sin ω t \qquad [ Equation 2 ]$$

In Equation 2, since all of the remaining parts excluding ω have a constant, the restored sound wave signals do not change with time or frequency, so that sound waves having a predetermined amplitude may be restored from the ultrasonic waves.

FIG. 6 is a flowchart showing a method for transmitting sound waves in water according to another embodiment of the present invention.

In step S601, a first sound wave transmission apparatus may generate first sound wave signals, and a second sound wave transmission apparatus may generate second sound wave signals.

Next, in step S603, the first sound wave transmission apparatus may modulate the first sound wave signals into first ultrasonic signals to generate the first ultrasonic signals, and the second sound wave transmission apparatus may modulate the second sound wave signals into second ultrasonic signals to generate the second ultrasonic signals.

Here, the first and second sound wave transmission apparatuses may each perform SSB AM on corresponding sound wave signals to generate ultrasonic signals. In addition, the first sound wave signals and the second sound wave signals may include sound wave signals having the same characteristics.

Next, in step S605, the first sound wave transmission apparatus may perform pre-distortion with respect to the first ultrasonic signals, and the second sound wave transmission apparatus may perform pre-distortion with respect to the second ultrasonic signals.

Here, the pre-distortion refers to pre-processing for preventing distortion in which the amplitude of the sound wave signals restored from the ultrasonic signals is increased in proportion to the square of a frequency component of sound waves, as described in Equations 1 and 2.

In addition, in step S607, the first and second sound wave transmission apparatuses may amplify the first and second ultrasonic signals so that the first and second ultrasonic signals on which the pre-distortion has been performed may be transmitted to a human body in water.

Next, in step S609, the first and second sound wave transmission apparatuses may transmit, in water, the first and second ultrasonic signals on which the pre-distortion and/or amplification has been performed as described above. Here, it is preferable that the first and second sound wave transmission apparatuses transmit the first and second ultrasonic signals so that the first and second ultrasonic signals cross each other at a user's position in water or in the vicinity of the user.

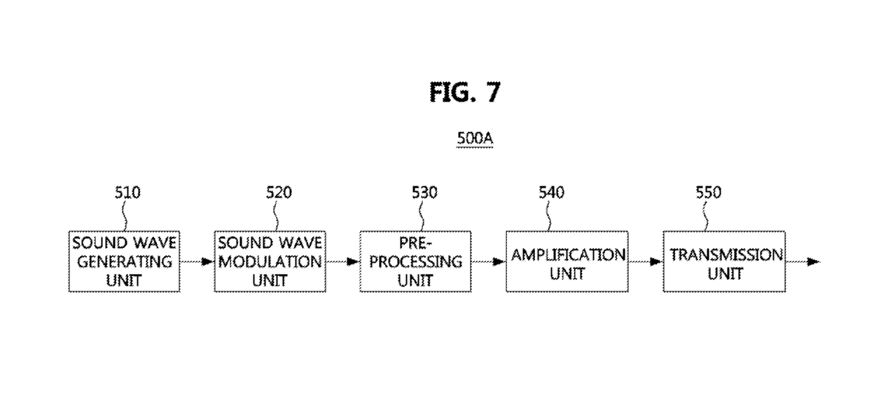

FIG. 7 is a block diagram showing a configuration of an apparatus for transmitting sound waves according to another embodiment of the present invention.

Referring to FIG. 7, the apparatus for transmitting sound waves according to another embodiment of the present invention may include a sound wave generating unit 510, a sound wave modulation unit 520, a pre-processing unit 530, an amplification unit 540, and a transmission unit 550.

The sound wave generating unit 510 may receive sound wave signals of an audible frequency band provided from a sound source and transmit the received sound wave signals to the sound wave modulation unit 520, or convert the sound wave signals into a specific format which can be processed in the sound wave modulation unit 520 and then provide the converted sound wave signals to the sound wave modulation unit 520. Here, the sound wave generating unit 510 may read sound wave data stored in the apparatus for transmitting sound waves and transmit the read sound wave data to the sound wave modulation unit 520, or transmit sound waves signals provided from an external device to the sound wave modulation unit 520. In addition, the sound wave generating unit may convert the sound wave signals into a specific format such as a PCM data format, and then provide the converted sound wave signals to the sound wave modulation unit 520.

The sound wave modulation unit 520 may generate ultrasonic signals by performing SSB AM with respect to the provided sound wave signals.

The pre-processing unit 530 may minimize generation of sound waves signals restored from the ultrasonic signals by performing the pre-distortion with respect to the modulated ultrasonic signals, as shown in Equation 2.

The amplification unit 540 may amplify the ultrasonic signals so that the ultrasonic signals on which the pre-processing has been performed may reach a user's body in water.

The transmission unit 550 may transmit, in water, the ultrasonic signals generated through the above-described process through direct contact with water.

In FIG. 7, for convenience of description, a configuration of one apparatus 500a for transmitting sound waves has been described, but in the method for transmitting sound waves according to another embodiment of the present invention, the two apparatuses 500a and 500b transmit the ultrasonic signals so that the ultrasonic signals cross each other at a specific position in water, as shown in FIGS. 5 and 6, and therefore one more apparatus for transmitting sound waves may be used, as shown in FIG. 7.

As described above, according to the embodiments of the present invention, in the method and apparatus for transmitting sound waves in water, the sound waves may be transmitted to a human body through water, which has a similar impedance to the human body, and therefore an apparatus for receiving sound signals is not required, unlike in existing apparatuses for transmitting sound signals, and direct contact between the human body and the apparatus for transmitting sound signals is not required, thereby making it more convenient to use.

In addition, even when a human body is constantly moving while the apparatus for transmitting sound waves or the transmission unit of the apparatus is in contact with water, a superior contact condition may be provided, and therefore sound waves may be more effectively transmitted to a user.

In addition, sound waves may be transmitted in a specific area in water using ultrasonic waves, so that an area to which the sound waves are transmitted may be adjusted in water and ultrasonic signals may be subjected to pre-distortion and transmitted based on distortion that may occur when modulated ultrasonic waves are demodulated, thereby minimizing distortion of the restored sound waves.

While the example embodiments of the present invention and their advantages have been described in detail, it should be understood that various changes, substitutions and alterations may be made herein without departing from the scope of the invention.

What is claimed is:

1. A method for transmitting sound waves in water, comprising:
generating a sound wave signal; and
transmitting the sound wave signal in water.

2. The method of claim 1, further comprising:
generating a compensation signal for preventing distortion due to water vibration in an audible frequency band; and
simultaneously transmitting the compensation signal and the sound wave signal in water.

3. A method for transmitting sound waves in water, comprising:
generating a first ultrasonic signal and a second ultrasonic signal; and
transmitting each of the first ultrasonic signal and the second ultrasonic signal in water,
wherein the first ultrasonic signal and the second ultrasonic signal are transmitted so as to cross each other in a specific location in water.

4. The method of claim 3, wherein the generating of the first ultrasonic signal and the second ultrasonic signal includes:
receiving a sound wave signal, and
generating the first ultrasonic signal and the second ultrasonic signal using the sound wave signal.

5. The method of claim 4, wherein the generating of the first ultrasonic signal and the second ultrasonic signal using the sound wave signal includes performing pre-distortion for compensating for distortion that occurs when the first ultrasonic signal and the second ultrasonic signal are restored to the sound wave signal.

6. The method of claim 5, wherein the performing of the pre-distortion divides the first ultrasonic signal and the second ultrasonic signal by the square of frequency of the sound waves.

7. An apparatus for transmitting sound waves in water, comprising:
a sound wave generating unit that generates an ultrasonic signal by modulating a provided sound wave signal;
a pre-processing unit that performs pre-distortion on the ultrasonic signal; and
a transmission unit that transmits, in water, the ultrasonic signal on which the pre-distortion has been performed.

8. The apparatus of claim 7, wherein the pre-processing unit divides the ultrasonic signal by the square of frequency of the sound wave signal so as to compensate for distortion occurring when the ultrasonic signal is restored to the sound wave signal.
